(19) United States
(12) Patent Application Publication
(10) Pub. No.: US 2026/0107170 A1
(43) Pub. Date: Apr. 16, 2026

(54) DATA COLLECTION METHOD, DATA COLLECTION APPARATUS, COMMUNICATION DEVICE, AND STORAGE MEDIUM

(71) Applicant: VIVO MOBILE COMMUNICATION CO., LTD., Guangdong (CN)

(72) Inventors: Yannan YUAN, Guangdong (CN); Fei QIN, Guangdong (CN)

(73) Assignee: VIVO MOBILE COMMUNICATION CO., LTD., Guangdong (CN)

(21) Appl. No.: 19/409,308

(22) Filed: Dec. 4, 2025

Related U.S. Application Data
(63) Continuation of application No. PCT/CN2024/096202, filed on May 30, 2024.

(30) Foreign Application Priority Data
Jun. 6, 2023 (CN) 202310668849.5

(51) Int. Cl. H04W 24/08; H04W 8/18

(52) U.S. Cl. CPC H04W 24/08; H04W 8/18

(57) ABSTRACT

This application discloses a data collection method, a data collection apparatus, a communication device, and a storage medium. The data collection method according to the embodiments of this application includes: determining, by a first function node based on an obtained data profile after receiving a first data request, collection state information of first data requested by the first data request, where the data profile is used for describing information of data that is being collected or has been collected by a data providing function node; and determining, by the first function node based on the collection state information of the first data, a data providing function node for providing the first data or a data repository function node, where the data repository function node is used for storing data collected by the data providing function node.

### CROSS-REFERENCE TO RELATED APPLICATIONS

This application is a continuation application of PCT International Application No. PCT/CN2024/096202 filed on May 30, 2024, which claims priority to Chinese Patent Application No. 202310668849.5, filed on Jun. 6, 2023 in China, which is incorporated herein by reference in its entirety.

### TECHNICAL FIELD

This application belongs to the field of wireless communication technologies, and in particular, to a data collection method, a data collection apparatus, a communication device, and a storage medium.

### BACKGROUND

In related protocol standards, a network data analytics function (NWDAF) and an analytics data repository function (ADRF) in a core network are mainly considered for data collection, and collected data is registered to a data collection coordination function (DCCF), so that the DCCF determines, based on a data requirement, whether required data is being or has been collected by the NWDAF or the ADRF. However, another network function of the core network and a network function of the radio access network cannot register the collected data, and in cross-domain (between the radio access network (RAN) and the core network (CN)) data sharing, internal information of the RAN or internal information of the CN is prone to exposure.

### SUMMARY

Embodiments of this application provide a data collection method, a data collection apparatus, a communication device, and a storage medium.

According to a first aspect, a data collection method is provided and performed by a first function node, and the method includes:
determining, by a first function node based on an obtained data profile after receiving a first data request, collection state information of first data requested by the first data request, where the data profile is used for describing information of data that is being collected or has been collected by a data providing function node; and
determining, by the first function node based on the collection state information of the first data, a data providing function node for providing the first data or a data repository function node, where the data repository function node is used for storing data collected by the data providing function node.

According to a second aspect, a data collection method is provided and performed by a second function node or a third function node, and the method includes:
sending, by a second function node or a third function node, a data profile to a first function node, where the data profile is used for describing information of data that is being collected or has been collected by the second function node, and the third function node is used for storing the data collected by the second function node.

According to a third aspect, a data collection apparatus is provided, and includes:
a first determining module, configured to determine, based on an obtained data profile after receiving a first data request, collection state information of first data requested by the first data request, where the data profile is used for describing information of data that is being collected or has been collected by a data providing function node; and
a second determining module, configured to determine, based on the collection state information of the first data, the data providing function node for providing the first data or a data repository function node, where the data repository function node is used for storing data collected by the data providing function node.

According to a fourth aspect, a data collection apparatus is provided, and includes:
a first sending module, configured to send a data profile to a first function node, where the data profile is used for describing information of data that is being collected or has been collected by a second function node.

According to a fifth aspect, a communication device is provided, and the communication device includes a processor and a memory, where the memory stores a program or an instruction that can be run on the processor, and when the program or the instruction is executed by the processor, the steps of the method according to the first aspect or the second aspect are implemented.

According to a sixth aspect, a communication device is provided, including a processor and a communication interface. The processor is configured to determine, based on an obtained data profile after receiving a first data request, collection state information of first data requested by the first data request, where the data profile is used for describing information of data that is being collected or has been collected by a data providing function node; and determine, based on the collection state information of the first data, the data providing function node for providing the first data or a data repository function node, where the data repository function node is used for storing data collected by the data providing function node.

According to a seventh aspect, a communication device is provided, including a processor and a communication interface. The communication interface is configured to send a data profile to a first function node, where the data profile is used for describing information of data that is being collected or has been collected by the second function node, and the third function node is used for storing the data collected by the second function node.

According to an eighth aspect, a readable storage medium is provided, where the readable storage medium stores a program or an instruction, and when the program or the instruction is executed by a processor, the steps of the method according to the first aspect or the second aspect are implemented.

According to a ninth aspect, a wireless communication system is provided, including a first function node and a second function node/third function node, where the first function node may be configured to perform the steps of the method according to the first aspect, and the second function node/third function node may be configured to perform the steps of the method according to the second aspect.

According to a tenth aspect, a chip is provided. The chip includes a processor and a communication interface. The communication interface is coupled to the processor. The processor is configured to run a program or an instruction, to implement the method according to the first aspect or the second aspect.

According to an eleventh aspect, a computer program/program product is provided, where the computer program/program product is stored in a storage medium, and the computer program/program product is executed by at least one processor to implement the steps of the method according to the first aspect or the second aspect.

### BRIEF DESCRIPTION OF DRAWINGS

FIG. 1 is a block diagram of a wireless communication system to which embodiments of this application may be applied;

FIG. 2 is a schematic diagram of a data collection system architecture using a DCCF;

FIG. 3 is a schematic diagram of an exposure system architecture of network data analytics using a DCCF;

FIG. 4 is a schematic flowchart of a data collection method in related art;

FIG. 5 is a schematic diagram of a data plane;

FIG. 6 is a schematic flowchart of a data collection method performed by a first function node according to an embodiment of this application;

FIG. 7 is a schematic flowchart of a data collection method performed by a second function node or a third function node according to an embodiment of this application;

FIG. 8 is a first schematic diagram of a structure of a data collection apparatus according to an embodiment of this application;

FIG. 9 is a second schematic diagram of a structure of a data collection apparatus according to an embodiment of this application;

FIG. 10 is a schematic diagram of a structure of a communication device according to an embodiment of this application;

FIG. 11 is a schematic diagram of a hardware structure of a terminal according to an embodiment of this application;

FIG. 12 is a first schematic diagram of a hardware structure of a network side device according to an embodiment of this application; and

FIG. 13 is a second schematic diagram of a hardware structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication can be understood as that a sender clearly informs a receiver of specific information, an operation required to be performed, a request result, or the like in a sent indication; and the indirect indication can be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are in most of the following descriptions, but these technologies can also be applied to a system other than the NR system, for example, a 6^{th} generation (6G) communication system.

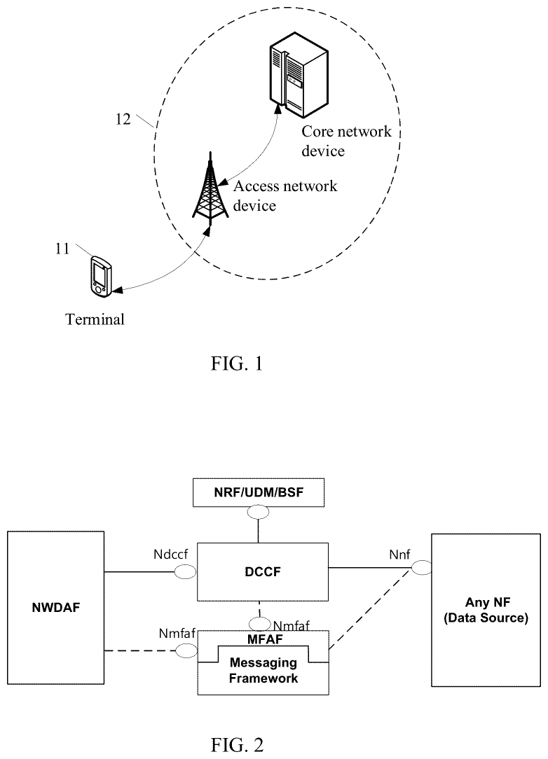

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship-borne equipment, pedestrian user equipment (PUE), smart household (household devices with wireless communication functions, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a network function of a radio access network, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

The technical points involved in this application are briefly described below.

### 1. 5G Network Data Analytics Service

A network data analytics function (NWDAF) is one of network functions of a control plane of a 5G core network (5GC), which may interact with different entities for different purposes, such as:
(1) Collect data based on event subscription provided by AMF, SMF, PCF, UDM, AF (directly or through NEF), or operation administration maintenance (OAM);
(2) [Optional] Use data collection coordination function (DCCF) for analytics and data collection;
(3) Retrieve information from a data repository (for example, retrieve UDR of user-related information through UDM);
(4) [Optional] Store and retrieve information from an analytics data repository function (ADRF);
(5) Analyze and collect data from a messaging framework adaptor function (MFAF);
(6) Retrieve information about network functions (NFs) (for example, retrieve information related to the NFs from the NRF);
(7) Provide analytics to consumers based on demands; and
(8) Provide consumers with a large amount of data.

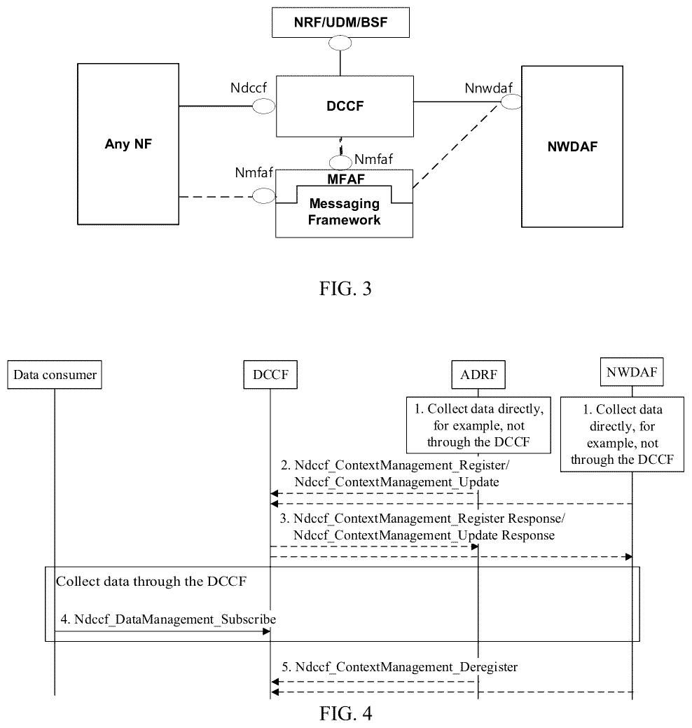

Referring to FIG. 2 and FIG. 3, FIG. 2 is a schematic diagram of a data collection system architecture using a DCCF, and FIG. 3 is a schematic diagram of an exposure system architecture of network data analytics using a DCCF.

In some cases, a data consumer (such as the NWDAF or the ADRF) directly collects data from a data source network function (NF). For example, when the NWDAF is co-located with a 5GC NF, the NWDAF or the ADRF may register/update a data collection profile/configuration file with the DCCF during or after a data collection process, to enable the data consumer to directly obtain data collected by the NWDAF or the ADRF (that is, not through the DCCF). Then, the DCCF may determine that the requested data is available in the NWDAF or the ADRF, and may coordinate data collection based on the data collection profile/configuration file. Referring to FIG. 4, the process is briefly described as follows.

Step 1: One ADRF or NWDAF instance is collecting or has collected data directly, for example, from a co-located NF.

Step 2: The ADRF or the NWDAF requests the DCCF to register/update the data collection profile/configuration file (may include a service operation, an analytics/data specification, an ADRF ID, or an NWDAF ID) by invoking Ndccf_ContextManagement_Register or Ndccf_ContextManagement_Update. The registration/update request may be triggered by a data source (such as a co-located NF), and the trigger may be before the data collection starts or after the data collection is completed. The DCCF determines a data collection state of the NWDAF or the ADRF based on the analytics/data specification, for example, the DCCF determines whether the required data is being collected or has been collected. “Service operation” refers to a service used for collecting data or analytics from the data source (for example, Namf_EventExposure_Subscribe or Nnwdaf_AnalyticsSubscription_Subscribe). “Analytics/data specification” is a specific parameter of “service operation” used for identifying the collected data (namely, analytics ID(s)/event ID(s), a target of an analytics report or a target of an event report, an analytics filter or an event filter, or the like). The NWDAF ID or the ADRF ID specifies the ADRF or the NWDAF that registers the data collection profile/configuration file.

Step 3: The DCCF responds to the ADRF or the NWDAF with Ndccf_ContextManagement_Register Response or Ndccf_ContextManagement_Update Response.

Step 4: If the data consumer is configured to collect data through the DCCF by using a service operation of Ndccf_DataManagement_Subscribe, then required instant collection data or historical data may be collected through the DCCF based on a corresponding process.

Step 5: The ADRF or the NWDAF requests the DCCF to delete registration of data collection or analytics collection by invoking Ndccf_ContextManagement_Deregister.

### 2. Data Plane

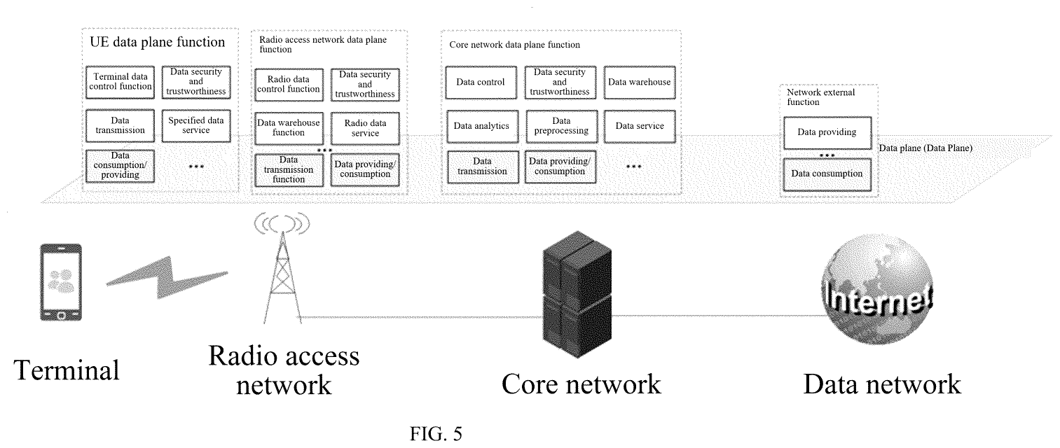

At present, in the discussion of 6G network architecture, many companies in the industry put forward the data plane. The data plane includes a core network data plane function, a radio access network data plane function, and a user equipment (UE) data plane function, and has end-to-end connectivity. The user equipment is also referred to as a terminal. The data plane is responsible for data control, including data collection coordination, data collection configuration, data transmission configuration, and the like. The data plane is further responsible for data collection, data transmission, data preprocessing, data privacy and security, data analytics, data storage, data service, and other functions. A schematic diagram of the data plane is shown in FIG. 5.

For data collection, there are the following problems in relevant schemes.

(1) In the related protocol standard, the NWDAF and the ADRF in the core network are mainly considered to register collected data to the DCCF, so that the DCCF determines, based on a data requirement, whether the data is being or has been collected by the NWDAF/ADRF. When data collection and sharing are ubiquitous in the future, data of the UE and the radio access network is also an important part of data collection and sharing, so it is necessary to support data collection and reuse of the UE and the radio access network.

(2) A data collection node of the existing data collection profile/configuration file scheme and a data collection profile registration node should be the same node, and they may be different in the future.

(3) The existing data collection profile includes the service operation and the specific parameter of the service operation. In cross-domain (radio access network (RAN) and core network (CN)) data sharing, unnecessary information exposure of internal information of the RAN or internal information of the CN should be avoided. Therefore, during cross-domain data sharing, a RAN domain data control function should be supported as a proxy of other RAN functions to provide data or data description information.

A data collection method, a data collection apparatus, a communication device, and a storage medium provided in the embodiments of this application are described below in detail with reference to the accompanying drawings by using some embodiments and application scenarios thereof.

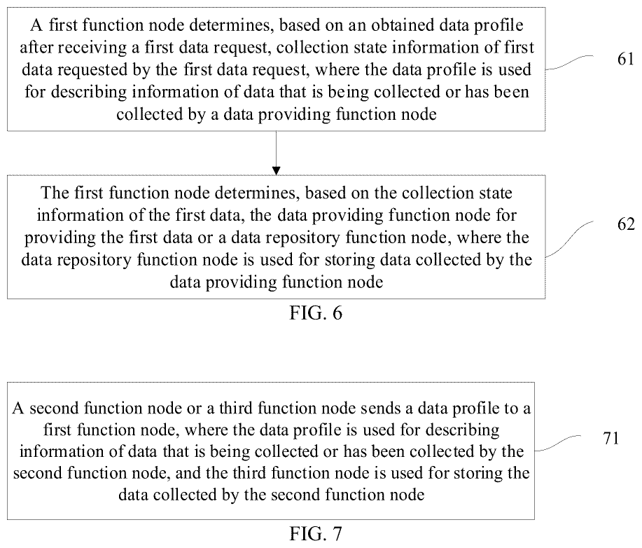

Referring to FIG. 6, an embodiment of this application provides a data collection method, including the following steps.

Step 61: A first function node determines, based on an obtained data profile after receiving a first data request, collection state information of first data requested by the first data request, where the data profile is used for describing information of data that is being collected or has been collected by a data providing function node.

Step 62: The first function node determines, based on the collection state information of the first data, the data providing function node for providing the first data or a data repository function node, where the data repository function node is used for storing data collected by the data providing function node.

In this embodiment of this application, by using the data profile, when registering data, the data providing function node does not need to transmit the data that is being collected or has been collected to the first function node, and only needs to transmit the data profile, to reduce an amount of data to be transmitted. In addition, data isolation of different domains is achieved to a certain extent, and data security is improved. The first function node obtains data profile information uniformly, which provides a more friendly data service for a data consumption function node and avoids the data consumption function node from maintaining a mapping relationship between required data and a data control function.

In this embodiment of this application, optionally, the first function node is used for performing data collection coordination.

In this embodiment of this application, optionally, the first data request is sent by the data consumption function node.

In this embodiment of this application, optionally, the data providing function node may include at least one of the following: the first function node and a second function node, and the second function node is a node for data collection or storage. If the first function node collects data as the data providing function node, the first function node may generate and store a data profile of data that is being collected or has been collected by the first function node. If the second function node collects data as the data providing function node, the second function node may generate a data profile of data that is being collected or has been collected by the second function node, and send the data profile to the first function node. Alternatively, in some cases, a storage capacity of the second function node is limited, and the collected data may be stored in a third function node (namely, the data repository function node). In this case, the third function node may generate the data profile of the data that is being collected or has been collected by the second function node, and send the data profile to the first function node. That is, the “data profile” obtained by the first function node may include at least one of the following: the data profile generated by the first function node, the data profile generated by the second function node, and the data profile generated by the third function node.

That is, in this embodiment of this application, a data collection node of the data profile and a data profile registration node may be different nodes or the same node.

In this embodiment, for UE with a limited storage capacity, or a network architecture with data collection and data storage decoupled, it not only supports the case in which the data profile registration node is different from a data providing node, but also supports the data providing node in registering the data profile as a proxy of the data collection node. This embodiment of this application extends to support the case in which the data collection node is different from the data profile registration node, thereby avoiding unnecessary intra-domain information sharing during cross-domain data sharing, not only providing data security, but also simplifying cross-domain data sharing.

In this embodiment of this application, optionally, the first function node may be a network function of the core network, such as a data control function (DCF), and the first function node may also be a network function of the radio access network, such as a radio access network data control function (RAN-DCF).

In this embodiment of this application, optionally, the second function node may be a network function of the core network, such as AMF, SMF, NWDAF, or ADRF, and the second function node may also be a network function of the radio access network, such as a base station (gNB), a radio access network data control function (RAN-DCF), a RAN exposure function, a centralized unit control plane (CU-CP), a centralized unit user plane (CU-UP), or a distributed unit (DU). Corresponding to a service capability exposure function (SCEF) and an NEF of the network function of the core network in the LTE or NR protocol, the RAN exposure function exposes a network capability of the 3GPP radio access network through interfaces such as an application programming interface (API). The second function node may also be a terminal (UE).

In some embodiments, optionally, both the first function node and the second function node may belong to the network function of the core network, for example, the first function node is DCF, and the second function node is AMF, SMF, NWDAF, ADRF, and the like.

In some embodiments, both the first function node and the second function node may belong to the network function of the radio access network, for example, the first function node is the radio access network data control function (RAN-DCF), and the second function node is CU-CP, CU-UP, DU, or the like.

In some embodiments, the first function node is the network function of the core network, and the second function node is the network function of the radio access network.

In some embodiments, the first function node is the network function of the core network, and the second function node is a terminal.

In some embodiments, the first function node is the network function of the radio access network, and the second function node is a terminal.

That is, in this embodiment of this application, scenarios of data collection are expanded. Not only the case in which the NWDAF and the ADRF in the core network register collected data to the DCCF is considered, but also data collection of the UE and the radio access network is supported.

In this embodiment of this application, optionally, the collection state information of the first data includes one of the following: the first data is being collected or has been collected; first partial data of the first data is being collected or has been collected; and the first data is not collected.

In this embodiment of this application, optionally, that the first function node determines, based on the collection state information of the first data, the data providing function node for providing the first data or a data repository function node may include one of the following:
if it is determined, based on the obtained data profile, that the collection state information of the first data is: the first function node is collecting or has collected the first data, in this case, the first function node determines that the first function node is the data providing function node of the first data;
if it is determined, based on the obtained data profile, that the collection state information of the first data is: the first function node is collecting or has collected a part of data of the first data, in this case, the first function node determines that the first function node is the data providing function node of the first data;
if it is determined, based on the obtained data profile, that the collection state information of the first data is: the second function node is collecting or has collected the first data, in this case, the first function node determines that the second function node or the third function node is the data providing function node of the first data;
if it is determined, based on the obtained data profile, that the collection state information of the first data is: the second function node is collecting or has collected a part of data of the first data, in this case, the first function node determines that the second function node or the third function node is the data providing function node of the first data; and
if it is determined, based on the obtained data profile, that the collection state information of the first data is: the first data is not collected, in this case, the first function node determines that a node capable of generating the first data is the data providing function node of the first data.

In this embodiment of this application, optionally, the data profile may also be referred to as a data collection profile/configuration file or meta data, and the data profile is data information used for defining or explaining the collected data.

In this embodiment of this application, optionally, the data profile includes at least one of the following.

(1) Data profile identifier, used for uniquely identifying, within a control range of the first function node, the data profile and the data corresponding to the data profile.

(2) Data item, used for indicating data information, where the data information includes at least one of the following: a data name, a data identifier, a data set name, and a data set identifier.

The data name may be, for example, reference signal received power (RSRP), reference signal received quality (RSRQ), quality of experience (QoE), packet data convergence protocol (PDCP) delay, and the like.

The data identifier is, for example, identifier 1, identifier 2, and identifier 3, which respectively represent different data.

The data set name is, for example, a perception data set, where the perception data set includes delay, angle, Doppler, and signal strength; and an AI model data set, where the AI model data set includes models suitable for different scenarios (such as a low-speed user not greater than 3 km/h or a high-speed user greater than 120 km/h) and the like.

The data set identifier is, for example, identifier 1, identifier 2, and identifier 3, which respectively represent different data sets.

(3) Data collection control function node identifier, used for identifying a data collection control function node, where the data collection control function node is used for controlling the data providing function node to collect data.

In this embodiment of this application, optionally, the data collection control function node identifier includes at least one of the following: a data collection control function node ID, a data collection control function node IP address, and a data collection control function node port number.

In this embodiment of this application, if the second function node is a gNB or a similar network function node of the radio access network, the data collection control function node is usually a base station, and the data collection control function node identifier may be a gNB ID, a 6G radio access network node identifier, or a radio access network data control function (RAN-DCF) ID; and if the second function node is the network function of the core network, the data collection control function node may be the first function node, and the data collection control function node identifier may be a first function node identifier.

In this embodiment of this application, optionally, the first function node may modify and update the ongoing data collection based on the data collection control function node identifier, to meet the data requirement.

(4) Data providing function node identifier.

In this embodiment of this application, optionally, the first function node may obtain corresponding data based on the data providing function node identifier, or the first function node may configure, based on the data providing function node identifier, the first function node to provide the required first data to the data consumption function node.

In this embodiment of this application, it is assumed that the data providing function node has the network function of the radio access network, if the radio access network does not expect to expose the internal information of the RAN, the data providing function node identifier may be unified as a gNB ID, a 6G radio access network node identifier, a RAN exposure function ID, or the like. Even though the data may be data collected by the RAN-DCF, measurement data configured by the CU-CP, data obtained by measuring uplink data by the gNB or the like, data reported by the UE to the radio access network function node, or data obtained after the radio access network function node processes the data reported by the UE, the internal information of the RAN may be avoided from being exposed by using the unified identifier. If the core network needs to know the real data providing function node, the data providing function node needs to be specifically set as RAN-DCF, CU-CP, gNB, and the like based on the data providing function node. It should be noted that the data providing function node may also be different from a data profile providing function, for example, the data providing function node is UE A, and the data profile providing function is gNB x; or the data providing function node is CU-CP y, and the data profile providing function is RAN-DCF z.

(5) Data repository function node identifier.

(6) Data generation time.

Indicate a data generation time, to facilitate data retrieval by time or data association based on time.

(7) Data generation location.

Indicate a geographical location information of data generation, may be a tracking area, a RAN based notification area, a cell, an area range indicated by using coordinates, or the like.

(8) Measurement object corresponding to data.

Indicate content to be measured, such as measuring a white list cell, measuring a data radio bearer (DRB) identified as X, measuring a protocol data unit (PDU) session identified as Y, or measuring a quality of service (QOS) flow identified as Z.

(9) Data collection identifier, used for uniquely identifying, within a control range of the data providing function node, an association relationship between at least two of the following: a data item, a data collection control function node identifier, a data providing function node identifier, a data generation time, a data generation location, and a measurement object corresponding to data.

(10) Data type.

The data type may be one or more of user subscription data, network operation data, perception data, and artificial intelligence (AI) data, and may also be data with a data providing identifier or data without a data providing function node identifier.

(11) Data state, used for indicating information of a data life cycle in which data is located.

A simplified data life cycle definition method includes a generation period and a use period, where the generation period indicates that data is being generated and collected, and the use period indicates that data may be used by each data consumption function node. The data may be in the generation period or the use period, or may be in both the generation period and the use period.

Another data life cycle definition method includes a generation period, an activity period, a decline period, an archive period, and a destruction period. The activity period, the decline period, and the archive period are all defined based on a frequency of data access, for example, the access frequency is higher than a first threshold in the activity (active) period; the access frequency is lower than a second threshold and higher than a third threshold in the decline period, where after entering the decline period, data activities are decreasing, and if there is a violent activity, it may be unexpected and usually indicates rediscovery of data value or occurrence of a data security incident; and the access frequency is lower than the third threshold in the archive period, and in this case, data access enters a very sparse stage, and the data is no longer updated. When the data has no use value or has exceeded a regulatory retention period, the data needs to be destroyed, which is referred to as the destruction period.

Another data life cycle definition method is: data privacy and security, data generation and collection, data storage, data transmission, data processing, data consumption, data quality management, and the like. It is divided and defined based on various stages of data processing. For example, when data is being generated and collected, the data collection control function node may provide the first data by modifying the existing data collection; and if the data is in data repository, the data collection control function node may provide the first data by using the data repository function node.

(12) Data validity period.

Indicate how long the data is valid, which may be an absolute time, for example, valid before a certain day, a certain month, and a certain year, or a relative time, for example, valid one year after the data is generated. The data validity period may be set based on data value, wishes of a data provider, a regulatory retention period, and the like. The data provider may indicate, based on the wishes, the validity period during which the data may be used, and alternatively, a data collector may determine the validity period based on a size of storage space and/or a data access situation.

In this embodiment of this application, optionally, the first data request includes at least one of the following: a data item of the first data, a data generation time of the first data, a data generation location of the first data, and a measurement object corresponding to the first data. The first data request may be a data obtaining request or a data subscription request. The first function node determines, based on the first data request and the obtained data profile, collection state information of first data requested by the first data request.

In this embodiment of this application, optionally, the data collection method further includes: receiving, by the first function node, the data profile sent by the data providing function node or the data repository function node. Based on the data profile, the first function node may not only obtain the information of the data that is being collected or has been collected by the data providing function node, but also not need to transmit the data. Therefore, an amount of data to be transmitted is reduced, and the first function node can also coordinate and reuse the collected data well. Optionally, the data providing function node or the data repository function node may send the data profile to the first function node through data profile registration or data profile update.

In this embodiment of this application, optionally, the data collection method further includes: sending, by the first function node, data profile configuration information to the data providing function node or the data repository function node, where the data profile configuration information includes at least one of an update cycle of the data profile and event configuration information that triggers update of the data profile. The event configuration information that triggers update of the data profile is, for example, to send the data profile when a data generation location appears, or to send the data profile when data of a data providing function node appears. The data providing function node or the data repository function node sends the data profile to the first function node based on the data profile configuration information.

In this embodiment of this application, optionally, before the determining, based on an obtained data profile, collection state information of first data requested by the first data request, further including: determining, by the first function node, that the first data request is authorized. That is, the first function node needs to determine, based on authorization information, whether the data consumption function node may access the required first data. If it is accessible, the first function node determines, based on the first data request sent by the data consumption function node and the obtained data profile information, whether the required first data is being collected or has been collected. If it is not accessible, the first function node may send a rejection response message to the data consumption function node, and optionally, the rejection response message indicates that the reason is authentication failure.

In this embodiment of this application, optionally, after the determining, by the first function node based on the collection state information of the first data, a data providing function node for providing the first data or a data repository function node, further including: sending, by the first function node, a first data response to a data consumption function node that sends the first data request, where the first data response includes at least one of the following: a data providing function node identifier, a data repository function node identifier, and a data collection identifier. That is, in this embodiment, the data is provided to the data consumption function node by the data providing function node or the data repository function node.

In this embodiment of this application, optionally, the data collection method further includes: sending, by the first function node, a second data request to the data providing function node or the data repository function node, where the second data request is used for instructing the data providing function node or the data repository function node to provide the first data to the data consumption function node. In this embodiment of this application, optionally, when a data service option (that is, a manner in which the data consumption function node obtains data) is to obtain data by using a messaging framework (messaging bus, such as Kafka), the data providing function node or the data repository function node publishes data to the messaging framework, and the data consumption function node obtains the required first data based on the messaging framework.

In this embodiment of this application, optionally, based on the collection state information of the first data, there are the following cases.

(1) The sending, by the first function node, a first data response to a data consumption function node that sends the first data request includes: when the collection state information of the first data indicates that the first data is being collected or has been collected, sending, by the first function node, the first data response to the data consumption function node that sends the first data request.

In this case, that the first data is being collected or has been collected may be: the first function node is collecting or has collected the first data, or the second function node is collecting or has collected the first data.

(2) When the collection state information of the first data indicates that first partial data of the first data is being collected or has been collected, before the sending, by the first function node, a first data response to a data consumption function node that sends the first data request, further including: sending, by the first function node, data collection modification information to a data providing function node corresponding to the first partial data, and modifying a data profile corresponding to the first partial data (to match data collection modification), where the data collection modification information is used for instructing the data providing function node corresponding to the first partial data to collect second partial data of the first data, and the second partial data is data of the first data other than the first partial data.

In this embodiment of this application, the data providing function node may be the first function node or the second function node. When it is the second function node, the first function node sends the data collection modification information to the second function node, and when it is the first function node, the data collection modification information is sent within the first function node.

(3) When the collection state information of the first data indicates that the first data is not collected (the data being collected or has been collected does not include the first data), before the sending, by the first function node, a first data response to a data consumption function node that sends the first data request, further including: determining, by the first function node, a data providing function node for collecting the first data, and sending data collection configuration information to the data providing function node for collecting the first data, where the data collection configuration information includes at least one of the following: a data item of the first data, a data generation time of the first data, a data generation location of the first data, and a measurement object corresponding to the first data.

In this embodiment of this application, the data providing function node for collecting the first data may be the first function node or the second function node. When it is the second function node, the first function node sends the data collection configuration information to the second function node, and the second function node collects data. When it is the first function node, the data collection configuration information is sent within the first function node, and the first function node collects data.

In this embodiment of this application, optionally, after the determining the data providing function node for providing the first data or a data repository function node, further including: sending, by the first function node, a second data response or first notification information to a data consumption function node that sends the first data request, where the second data response includes the first data, and the first notification information is used for notifying the data consumption function node that the first data is subscribed successfully. That is, in this embodiment, the data is provided to the data consumption function node by the first function node.

In this embodiment of this application, optionally, before the sending, by the first function node, a second data response or first notification information to the data consumption function node that sends the first data request, further including:
sending, by the first function node, a third data request to the data providing function node or the data repository function node, where the third data request is used for instructing the data providing function node or the data repository function node to provide the first data to the first function node; and
receiving, by the first function node, the first data sent by the data providing function node or the data repository function node.

In this embodiment of this application, optionally, the third data request includes a data profile identifier corresponding to the first data.

In this embodiment of this application, optionally, based on the collection state information of the first data, there are the following cases.

(1) The sending, by the first function node, a third data request to the data providing function node or the data repository function node includes: when the collection state information of the first data indicates that the first data is being collected or has been collected, sending, by the first function node, the third data request to the data providing function node or the data repository function node corresponding to the first data.

In this embodiment of this application, the data providing function node may be the first function node or the second function node. When it is the second function node, the first function node sends the third data request to the second function node, and when it is the first function node, the third data request is sent within the first function node.

(2) When the collection state information of the first data indicates that first partial data of the first data is being collected or has been collected, before the sending, by the first function node, the third data request to the data providing function node or the data repository function node, further including: sending, by the first function node, data collection modification information to a data providing function node corresponding to the first partial data, and modifying the data profile corresponding to the first data, where the data collection modification information is used for instructing to collect second partial data of the first data, and the second partial data is data of the first data other than the first partial data.

In this embodiment of this application, the data providing function node may be the first function node or the second function node. When it is the second function node, the first function node sends the data collection modification information to the second function node, and when it is the first function node, the data collection modification information is sent within the first function node.

In this embodiment of this application, optionally, the data collection modification information includes at least one of the following: a data profile identifier and a new data item.

(3) When the collection state information of the first data indicates that the first data is not collected, before the sending, by the first function node, the third data request to the data providing function node or the data repository function node, further including: determining, by the first function node, a data providing function node for collecting the first data, and sending data collection configuration information to the data providing function node for collecting the first data, where the data collection configuration information includes at least one of the following: a data item of the first data, a data generation time of the first data, a data generation location of the first data, and a measurement object corresponding to the first data.

In this embodiment of this application, the data providing function node for collecting the first data may be the first function node or the second function node. When it is the second function node, the first function node sends the data collection configuration information to the second function node, and the second function node collects data. When it is the first function node, the data collection configuration information is sent within the first function node, and the first function node collects data.

In this embodiment of this application, optionally, when the collection state information of the first data indicates that first partial data of the first data is being collected or has been collected, the method further includes: sending, by the first function node, a data format template of the first data to the data providing function node or the data repository function node.

In this embodiment of this application, optionally, when the collection state information of the first data indicates that the first data is not collected, after the determining, by the first function node, the data providing function node, further including: generating, by the first function node, a data profile corresponding to the data providing function node. It is convenient to determine whether the requested data is being collected or has been collected when a data request is received subsequently.

When a storage space of the second function node is limited, a corresponding data validity period is usually short. If the first function node may obtain data from the second function node to extend the data validity period, it may provide longer-term historical data for potential data reuse. In this embodiment of this application, optionally, the data collection method further includes:
sending, by the first function node, a fourth data request to the data providing function node, where the fourth data request is used for updating a data validity period of second data, the second data is data that is being collected or has been collected by the data providing function node and that is stored by the data providing function node, and the fourth data request includes at least one of the following: a data profile identifier, a data validity period, and a data repository function node identifier;
receiving, by the first function node, the second data sent by the data providing function node, or receiving second notification information sent by the data providing function node or the data repository function node, where the second notification information is used for indicating that the second data has been sent to the data repository function node by the data providing function node; and
updating, by the first function node, a data validity period and a data providing function node identifier in a data profile corresponding to the second data.

That is, the data providing function node is identified as the first function node identifier or the data repository function node identifier.

In this embodiment of this application, the first function node may be responsible for one or more of data reporting configuration, data transmission configuration, and data processing configuration in addition to data collection coordination. The following describes the data reporting configuration, the data transmission configuration, and the data processing configuration respectively.

(1) Data reporting configuration

Data reporting configuration refers to configuration of data packet encapsulation of data provided by the data providing function node or the data repository function node.

In this embodiment of this application, optionally, the data collection method further includes: sending, by the first function node, data reporting configuration information to the data providing function node or the data repository function node, where the data reporting configuration information includes at least one of the following:
a data packet length;
distribution characteristics of data packet lengths;
a data packet time interval;
distribution characteristics of time intervals for data packet transmission;
whether the data providing function node performs data encryption;
whether the data providing function node performs data scrambling;
a key used by the data providing function node for data scrambling; and
a scrambling sequence used by the data providing function node for data scrambling.

(2) Data transmission configuration

In this embodiment of this application, optionally, the data collection method further includes at least one of the following:
establishing, modifying, or releasing, by the first function node, a data transmission channel for transmitting data by the data providing function node or the data repository function node; and
performing, by the first function node, quality of service (QOS) management on the data transmission channel.

(3) Data processing configuration

In this embodiment of this application, optionally, the data collection method further includes: sending, by the first function node, data processing configuration information to at least one of the data providing function node, the data repository function node, and the data consumption function node, where the data processing configuration information includes at least one of the following: data preprocessing (such as filtering and anonymization) configuration information and data analytics configuration information.

The data providing function node or the data repository function node is a data transmission node, and the data consumption function node is a data receiving node.

Referring to FIG. 7, an embodiment of this application further provides a data collection method, including the following steps.

Step 71: A second function node or a third function node sends a data profile to a first function node, where the data profile is used for describing information of data that is being collected or has been collected by the second function node, and the third function node is used for storing the data collected by the second function node.

In this embodiment of this application, by using the data profile, when registering data, the data providing function node does not need to transmit the data that is being collected or has been collected to the first function node, and only needs to transmit the data profile, to reduce an amount of data to be transmitted. In addition, data isolation of different domains is achieved to a certain extent, and data security is improved.

In this embodiment of this application, optionally, the second function node or the third function node may send the data profile to the first function node through data profile registration or data profile update.

In this embodiment of this application, optionally, the data profile includes at least one of the following:
a data profile identifier, used for uniquely identifying, within a control range of the first function node, the data profile and the data corresponding to the data profile;
a data item, used for indicating data information, where the data information includes at least one of the following: a data name, a data identifier, a data set name, and a data set identifier;
a data collection control function node identifier, used for identifying a data collection control function node, where the data collection control function node is used for controlling the data providing function node to collect data;
a data providing function node identifier, where the data providing function node is the second function node;
a data repository function node identifier, where the data repository function node is the third function node;
a data generation time;
a data generation location;
a measurement object corresponding to data;
a data collection identifier, used for uniquely identifying, within a control range of the second function node, an association relationship between at least two of the following: a data item, a data collection control function node identifier, a data providing function node identifier, a data generation time, a data generation location, and a measurement object corresponding to data;
a data type;
a data state, used for indicating information of a data life cycle in which data is located; and
a data validity period.

In this embodiment of this application, optionally, the data collection method further includes:
receiving, by the second function node or the third function node, data profile configuration information sent by the first function node, where the data profile configuration information includes at least one of an update cycle of the data profile and event configuration information that triggers update of the data profile;
or
obtaining, by the second function node or the third function node, an identifier of the first function node and the data profile configuration information based on configuration information of a network management function.

In this embodiment of this application, optionally, the data collection method further includes:
receiving, by the second function node or the third function node, a second data request sent by the first function node, where the second data request is used for instructing the second function node or the third function node to provide the first data to a data consumption function node;
or
receiving, by the second function node or the third function node, a third data request sent by the first function node, where the third data request is used for instructing the second function node or the third function node to provide the first data to the first function node.

In this embodiment of this application, optionally, the third data request includes a data profile identifier corresponding to the first data.

In this embodiment of this application, optionally, the data collection method further includes:
providing, by the second function node or the third function node, the first data to the first function node or the data consumption function node.

In this embodiment of this application, optionally, the data collection method further includes:
receiving, by the second function node, data collection modification information sent by the first function node, where the data collection modification information is used for instructing the second function node to collect second partial data of the first data, the second function node is collecting or has collected first partial data of the first data, and the second partial data is data of the first data other than the first partial data.

In this embodiment of this application, optionally, the data collection method further includes:
receiving, by the second function node, a data format template of the first data sent by the first function node.

In this embodiment of this application, optionally, the data collection method further includes:
receiving, by the second function node or the third function node, a fourth data request sent by the first function node, where the fourth data request is used for updating a data validity period of second data, the second data is data that is being collected or has been collected by the second function node and that is stored by the second function node, and the fourth data request includes at least one of the following: a data profile identifier, a data validity period, and a data repository function node identifier; and
sending, by the second function node or the third function node, the second data to the first function node or the third function node based on the fourth data request.

In this embodiment of this application, optionally, the data collection method further includes:
receiving, by the second function node or the third function node, data reporting configuration information sent by the first function node, where the data reporting configuration information includes at least one of the following: a data packet length; distribution characteristics of data packet lengths; a data packet time interval; distribution characteristics of time intervals for data packet transmission; whether to perform data encryption; whether to perform data scrambling; a key used for data scrambling; and a scrambling sequence used for data scrambling; and
sending, by the second function node or the third function node, data to the first function node or the data consumption function node based on the data reporting configuration information.

In this embodiment of this application, optionally, the data collection method further includes:
receiving, by the second function node or the third function node, data processing configuration information sent by the first function node, where the data processing configuration information includes at least one of the following: data preprocessing configuration information and data analytics configuration information; and
processing, by the second function node or the third function node, data based on the data processing configuration information.

The following uses examples to describe the data collection method in the embodiments of this application with reference to specific application scenarios.

### Embodiment 1

In this embodiment, the first function node is the network function of the core network, and the second function node is the network function of the radio access network. The first function node controls the second function node to collect data, that is, the data providing function node is the second function node.

In this embodiment, it is assumed that the first function node is the network function of the core network, such as a core network data control function (CN-DCF), and the second function node is the network function of the radio access network, such as a base station (gNB), a radio access network data control function (RAN-DCF), or a RAN exposure function. This indicates that all data consumption function nodes make requests to the first function node of the core network, and then the first function node of the core network performs data collaboration. The advantage of performing data collaboration by the first function node of the core network is that data collaboration may be performed in a large range, and the data consumption function node does not need to make requests to different first function nodes based on data, a geographical location range, or the like. In this way, a data service is more friendly to the data consumption function node. By sending the data profile, in most cases, the second function node may achieve data isolation and reduce a data transmission amount to a certain extent with no need to send the data.

In this embodiment of this application, the data collection method includes the following steps.

Step 1: Optionally, the first function node sends data profile configuration information to the second function node, where the data profile configuration information includes at least one of an update cycle of the data profile and event configuration information that triggers update of the data profile. The event configuration information that triggers update of the data profile is, for example, to send the data profile when a data generation location appears, or to send the data profile when data of a data providing function node appears.

In some other embodiments of this application, the second function node may also obtain an identifier of the first function node and the data profile configuration information based on configuration information of a network management function.

Step 2: The second function node sends data profile registration or data profile update to the first function node based on the data profile configuration information. The data profile registration or the data profile update includes the data profile.

The data profile includes at least one of the following:
a data profile identifier such as M;
a data item such as RSRP, RSRQ, and PDCP delay;
a data collection control function node identifier. In this embodiment, an example in which the second function node is a gNB or a similar network function node of the radio access network is used, the data collection control function node is usually a base station, and the data collection control function node identifier may be a gNB ID, a 6G radio access network node identifier, or a radio access network data control function (RAN-DCF) ID; and if the second function node is the network function of the core network, the data collection control function node may be the first function node, and the data collection control function node identifier may be a first function node identifier;
a data providing function node identifier. If the radio access network does not expect to expose internal information of the RAN, the data providing function node identifier may be unified as a gNB ID, a 6G radio access network node identifier, a RAN exposure function ID, or the like. The data may be data collected by the RAN-DCF, measurement data configured by the CU-CP, data obtained by measuring uplink data by the gNB or the like, data reported by the UE to the radio access network function node, or data obtained after the radio access network function node processes the data reported by the UE. If the core network needs to know the real data providing function node, the data providing function node may also be different from a data profile providing function, for example, the data providing function node is UE A, and the data profile providing function is gNB x; or the data providing function node is CU-CP y, and the data profile providing function is RAN-DCF z;
a data generation time, indicating a time when the data is generated;
a data generation location. If the data is generated by measuring an uplink signal by the second function node, the data generation location may not be included, or the information is provided only once because a location of the base station is usually fixed;
a measurement object corresponding to data, such as a measurement cell list, a Doppler range of a measurement perception target, or a DRB list of UE;
a data collection identifier, which may be a measurement ID configured by the base station;
a data type, which may be one or more of user subscription data, network operation data, perception data, and AI data, and may also be data with a data providing identifier or data without a data providing function node identifier;
a data state, indicating a situation of the data in the data life cycle. A simplified data life cycle definition method includes a generation period and a use period, where the generation period indicates that data is being generated and collected, and the use period indicates that data may be used by each data consumption function node. The data may be in the generation period or the use period, or may be in both the generation period and the use period. Another data life cycle definition method includes a generation period, an activity period, a decline period, an archive period, and a destruction period. The activity period, the decline period, and the archive period are all defined based on a frequency of data access, for example, the access frequency is higher than a first threshold in the activity (active) period; the access frequency is lower than a second threshold and higher than a third threshold in the decline period, where after entering the decline period, data activities are decreasing, and if there is a violent activity, it may be unexpected and usually indicates rediscovery of data value or occurrence of a data security incident; and the access frequency is lower than the third threshold in the archive period, and in this case, data access enters a very sparse stage, and the data is no longer updated. When the data has no use value or has exceeded a regulatory retention period, the data needs to be destroyed, which is referred to as the destruction period. Another data life cycle definition method is: data privacy and security, data generation and collection, data storage, data transmission, data processing, data consumption, data quality management, and the like. It is divided and defined based on various stages of data processing. For example, when data is being generated and collected, the data collection control function node may provide the first data by modifying the existing data collection; and if the data is in data repository, the data collection control function node may provide the first data by using the data repository function node; and
a data validity period, indicating how long the data is valid, for example, the second function node determines the data validity period based on a size of storage space and/or a data access situation.

An example of a data profile corresponding to region-oriented data collection is as follows:
a data profile identifier: M;
a data item: RSRP, RSRQ, and PDCP delay;
a data collection control function node identifier: RAN-DCF ID;
a data providing function node identifier: RAN-DCF ID;
a data generation time: 11:00 a.m. to 12:00 a.m. every day;
a data generation location: xx office building;
a measurement object corresponding to data: uplink;
a data collection identifier: X;
a data type: data without a UE identifier and a cell identifier;
a data state: a generation period; and
a data validity period: one week.

Step 3: The first function node receives the data profile sent by the second function node, to obtain information of data that is being collected or has been collected by all controlled second function nodes.

When the first function node receives the data request of the data consumption function node, the related process is briefly described as follows.

Step 1: The first function node receives the first data request (the first data request may be the data obtaining request or the data subscription request) of the data consumption function node, where the first data request includes at least one of the following: a data item of the first data, a data generation time of the first data, a data generation location of the first data, and a measurement object corresponding to the first data.

Step 2: The first function node determines, based on authorization information, whether the data consumption function node may access the required first data. If it is accessible, the first function node determines, based on the first data request sent by the data consumption function node and the obtained data profile information, whether the required first data is being collected or has been collected. If it is not accessible, the first function node may send a rejection response message to the data consumption function node, and optionally, the rejection response message indicates that the reason is authentication failure.

When a data service option (that is, a manner in which the data consumption function node obtains data) is to obtain data by using a messaging framework (messaging bus, such as Kafka), step 3 is divided into the following three cases.

Step 3-1: When the collection state information of the first data indicates that the first data is being collected by the second function node or has been collected by the second function node, the first function node sends the first data response to the data consumption function node that sends the first data request, where the first data response includes at least one of the following: a second function node identifier and a data collection identifier. The second function node publishes data to the messaging framework, and the data consumption function node obtains the required first data based on the messaging framework.

Step 3-2: When the collection state information of the first data indicates that first partial data of the first data is being collected by the second function node or has been collected by the second function node, the first function node sends data collection modification information to the second function node, and modifies a data profile corresponding to the first partial data (to match data collection modification), where the data collection modification information is used for instructing the second function node to collect second partial data of the first data, and the second partial data is data of the first data other than the first partial data. For example, the data consumption function node requests X items of data, and the data being collected or has been collected by the second function node includes Y items of data in the X items of data (where X>Y). In this case, the first function node sends the data collection modification information to the second function node, to indicate the second function node to collect required X-Y items of data, and the first function node updates the data profile corresponding to the second function node, to match data collection modification. Optionally, the first function node sends a data format template of data required by the data consumption function node to the second function node, and the second function node processes collected data based on the data format template, to generate a data format meeting requirements of the data consumption function node. The first function node sends a first data response to the data consumption function node, where the first data response includes at least one of the following: a second function node identifier and a data collection identifier. The second function node publishes data to the messaging framework, and the data consumption function node obtains the required first data based on the messaging framework.

For example, the data format template may be as follows:

{
Cell ID
UE ID
UE speed range
Downlink RSRP
}

An example of time series may be in a manner of sorting sampling times.

{RSRP @T1, RSRP @T2 . . . }

Step 3-3: When the collection state information of the first data indicates that the first data is not collected, the first function node determines the data providing function node for collecting the first data, and sends data collection configuration information to the data providing function node for collecting the first data, where the data collection configuration information includes at least one of the following: a data item of the first data, a data generation time of the first data, a data generation location of the first data, and a measurement object corresponding to the first data. Optionally, the first function node may further generate corresponding data profile information. It is convenient to determine whether the requested data is being collected or has been collected when a data request is received subsequently. The first function node sends a first data response to the data consumption function node, where the first data response includes at least one of the following: a data providing function node identifier and a data collection identifier. The second function node publishes data to the messaging framework, and the data consumption function node obtains the required first data based on the messaging framework.

When a data service option (that is, a manner in which the data consumption function node obtains data) is to obtain data by using the first function node, step 3 is divided into the following three cases.

Step 3-1: When the collection state information of the first data indicates that the first data is being collected by the second function node or has been collected by the second function node, the first function node sends a third data request to the second function node. The third data request includes a data profile identifier corresponding to the first data. The second function node sends data to the first function node based on the data profile identifier. The first function node sends, based on a request response manner or a subscription manner, a second data response or first notification information to the data consumption function node, where the second data response includes the first data, and the first notification information is used for notifying the data consumption function node that the first data is subscribed successfully.

Step 3-2: When the collection state information of the first data indicates that first partial data of the first data is being collected by the second function node or has been collected by the second function node, the first function node sends data collection modification information to the second function node, and modifies a data profile corresponding to the first partial data (to match data collection modification), where the data collection modification information is used for instructing the second function node to collect second partial data of the first data, and the second partial data is data of the first data other than the first partial data. In this embodiment of this application, optionally, the data collection modification information includes at least one of the following: a data profile identifier and a new data item. For example, the data consumption function node requests X items of data, and the data being collected or has been collected by the second function node includes Y items of data in the X items of data (where X>Y). In this case, the first function node sends the data collection modification information to the second function node, to indicate the second function node to collect required X-Y items of data, and the first function node updates the data profile corresponding to the second function node, to match data collection modification. Optionally, the first function node sends a data format template of data required by the data consumption function node to the second function node, and the second function node processes collected data based on the data format template, to generate a data format meeting requirements of the data consumption function node. The first function node sends, based on a request response manner or a subscription manner, a second data response or first notification information to the data consumption function node, where the second data response includes the first data, and the first notification information is used for notifying the data consumption function node that the first data is subscribed successfully.

Step 3-3: When the collection state information of the first data indicates that the first data is not collected, the first function node determines the data providing function node for collecting the first data, and sends data collection configuration information to the data providing function node for collecting the first data, where the data collection configuration information includes at least one of the following: a data item of the first data, a data generation time of the first data, a data generation location of the first data, and a measurement object corresponding to the first data. Optionally, the first function node may further generate corresponding data profile information. It is convenient to determine whether the requested data is being collected or has been collected when a data request is received subsequently. Optionally, the first function node sends a data format template of data required by the data consumption function node to the second function node, and the second function node processes collected data based on the data format template, to generate a data format meeting requirements of the data consumption function node. The first function node sends, based on a request response manner or a subscription manner, a second data response or first notification information to the data consumption function node, where the second data response includes the first data, and the first notification information is used for notifying the data consumption function node that the first data is subscribed successfully.

### Embodiment 2

In this embodiment, the first function node is the network function of the core network or the network function of the radio access network, and the second function node is UE. The first function node controls the second function node to collect data, that is, the data providing function node is the second function node.

In this embodiment, it is assumed that the first function node is the network function of the core network (such as a core network data control function (CN-DCF)), or the network function of the radio access network (such as a radio access network data control function (RAN-DCF)).

In this embodiment, if the UE is a node with a local data repository, such as an automobile, the process is similar to that of Embodiment 1, and details are not repeated in this example. If a local storage capacity of the UE is limited, the collected data needs to be reported to the network for storage. It is assumed that the second function node UE is collecting data and/or has collected data, and the collected data is stored by the third function node. The UE may send a data profile corresponding to the collected data to the first function node, and an example of the data profile is as follows:
a data profile identifier: M;
a data item: RSRP, RSRQ, PDCP delay, and QoE;
a data providing function node identifier: UE ID;
a data generation time: 11:00 a.m. to 12:00 a.m. every day;
a data generation location: xx office building;
a measurement object corresponding to data: downlink;
a data collection identifier: X;
a data type: data with a UE identifier;
a data state: a generation period; and
a data validity period: one month.

The UE sends the collected data to the third function node, and indicates the data profile of the sent data to the third function node. One indication method is that the data sent by the UE carries the data profile identifier. An optimized indication method is that the UE includes at least a corresponding data profile identifier when sending a 1^{st} data packet, and a subsequent data packet indicates, by using indication information, whether it belongs to the previous data profile. If a plurality of data collections are performed simultaneously, to avoid ambiguity of data profile indication caused by data transmission disorder, data packet sequence numbers need to be added to data packets of different data collections, to distinguish the data packets corresponding to different data collections.

When the first function node receives a data request of the data consumption function node, and the data request needs to be provided by the UE, the related process is briefly described as follows.

Step 1: The first function node receives the first data request (the first data request may be the data obtaining request or the data subscription request) of the data consumption function node, where the first data request includes at least one of the following: a data item of the first data, a data generation time of the first data, a data generation location of the first data, and a measurement object corresponding to the first data.

Step 2: The first function node determines, based on authorization information, whether the data consumption function node may access the required first data. If it is accessible, the first function node determines, based on the first data request sent by the data consumption function node and the obtained data profile information, whether the required first data is being collected or has been collected. If it is not accessible, the first function node may send a rejection response message to the data consumption function node, and optionally, the rejection response message indicates that the reason is authentication failure.

When a data service option (that is, a manner in which the data consumption function node obtains data) is to obtain data by using a messaging framework (messaging bus, such as Kafka), the third function node storing UE data processes the UE data based on the data format template as a proxy of the second function node UE, and publishes the UE data to the messaging framework. Step 3 is divided into the following three cases.

Step 3-1: When the collection state information of the first data indicates that the first data is being collected by the second function node UE or has been collected by the second function node UE, the first function node sends the first data response to the data consumption function node that sends the first data request, where the first data response includes at least one of the following: a UE identifier, a third function node identifier, and a data collection identifier. The third function node publishes data to the messaging framework, and the data consumption function node obtains the required first data based on the messaging framework.

Step 3-2: When the collection state information of the first data indicates that first partial data of the first data is being collected by the second function node UE or has been collected by the second function node UE, the first function node sends data collection modification information to the second function node UE, and modifies a data profile corresponding to the first partial data (to match data collection modification), where the data collection modification information is used for instructing the UE to collect second partial data of the first data, and the second partial data is data of the first data other than the first partial data. For example, the data consumption function node requests X items of data, and the data being collected or has been collected by the second function node UE includes Y items of data in the X items of data (where X>Y). In this case, the first function node sends the data collection modification information to the second function node UE, to indicate the second function node UE to collect required X-Y items of data, and the first function node updates the data profile corresponding to the second function node UE, to match data collection modification. Optionally, the first function node sends a data format template of data required by the data consumption function node to the second function node UE or the third function node, and the second function node UE or the third function node processes, based on the data format template, data collected by the second function node UE, to generate a data format meeting requirements of the data consumption function node. The first function node sends a first data response to the data consumption function node, where the first data response includes at least one of the following: a UE identifier, a third function node identifier, and a data collection identifier. The third function node publishes data to the messaging framework, and the data consumption function node obtains the required first data based on the messaging framework.

Step 3-3: When the collection state information of the first data indicates that the first data is not collected, the first function node determines the data providing function node (such as the UE) for collecting the first data, and sends data collection configuration information to the data providing function node for collecting the first data, where the data collection configuration information includes at least one of the following: a data item of the first data, a data generation time of the first data, a data generation location of the first data, and a measurement object corresponding to the first data. Optionally, the first function node may further generate corresponding data profile information. It is convenient to determine whether the requested data is being collected or has been collected when a data request is received subsequently. The first function node sends a first data response to the data consumption function node, where the first data response includes at least one of the following: a second function node identifier, a third function node identifier, and a data collection identifier. The third function node publishes data to the messaging framework, and the data consumption function node obtains the required first data based on the messaging framework.

When a data service option (that is, a manner in which the data consumption function node obtains data) is to obtain data by using the first function node, step 3 is divided into the following three cases.

Step 3-1: When the collection state information of the first data indicates that the first data is being collected by the second function node UE or has been collected by the second function node UE, the first function node sends a third data request to the third function node. The third data request includes a data profile identifier corresponding to the first data. The third function node sends data to the first function node based on the data profile identifier. The first function node sends, based on a request response manner or a subscription manner, a second data response or first notification information to the data consumption function node, where the second data response includes the first data, and the first notification information is used for notifying the data consumption function node that the first data is subscribed successfully.

Step 3-2: When the collection state information of the first data indicates that first partial data of the first data is being collected by the second function node UE or has been collected by the second function node UE, the first function node sends data collection modification information to the second function node UE, and modifies a data profile corresponding to the first partial data (to match data collection modification), where the data collection modification information is used for instructing the second function node UE to collect second partial data of the first data, and the second partial data is data of the first data other than the first partial data. In this embodiment of this application, optionally, the data collection modification information includes at least one of the following: a data profile identifier and a new data item. For example, the data consumption function node requests X items of data, and the data being collected or has been collected by the second function node UE includes Y items of data in the X items of data (where X>Y). In this case, the first function node sends the data collection modification information to the second function node UE, to indicate the second function node UE to collect required X-Y items of data, and the first function node updates the data profile corresponding to the second function node UE, to match data collection modification. Optionally, the first function node sends a data format template of data required by the data consumption function node to the second function node UE or the third function node, and the second function node UE or the third function node processes the collected data based on the data format template, to generate a data format meeting requirements of the data consumption function node. The first function node sends, based on a request response manner or a subscription manner, a second data response or first notification information to the data consumption function node, where the second data response includes the first data, and the first notification information is used for notifying the data consumption function node that the first data is subscribed successfully.

Step 3-3: When the collection state information of the first data indicates that the first data is not collected, the first function node determines the data providing function node (such as the UE) for collecting the first data, and sends data collection configuration information to the data providing function node for collecting the first data, where the data collection configuration information includes at least one of the following: a data item of the first data, a data generation time of the first data, a data generation location of the first data, and a measurement object corresponding to the first data. Optionally, the first function node may further generate corresponding data profile information. It is convenient to determine whether the requested data is being collected or has been collected when a data request is received subsequently. Optionally, the first function node sends a data format template of data required by the data consumption function node to the second function node or the third function node, and the second function node or the third function node processes collected data based on the data format template, to generate a data format meeting requirements of the data consumption function node. The first function node sends, based on a request response manner or a subscription manner, a second data response or first notification information to the data consumption function node, where the second data response includes the first data, and the first notification information is used for notifying the data consumption function node that the first data is subscribed successfully.

### Embodiment 3

In this embodiment, the first function node is the network function of the core network or the network function of the radio access network, and the second function node is UE. The third function node registers and updates the data profile as a proxy of the UE.

In this embodiment, it is assumed that the first function node is the network function of the core network (such as a core network data control function (CN-DCF)), or the network function of the radio access network (such as a radio access network data control function (RAN-DCF)).

In this embodiment, if the UE is a node with a local data repository, such as an automobile, the process is similar to that of Embodiment 1, and details are not repeated in this example. If a local storage capacity of the UE is limited, the collected data needs to be reported to the network for storage. It is assumed that the second function node UE is collecting data and/or has collected data, and the collected data is stored by the third function node. The UE may send the collected data and the data profile to the third function node. An example of the data profile is as follows:
a data profile identifier: M;
a data item: RSRP, RSRQ, PDCP delay, and QoE;
a data providing function node identifier: UE ID;
a data generation time: 11:00 a.m. to 12:00 a.m. every day;
a data generation location: xx office building;
a measurement object corresponding to data: downlink;
a data collection identifier: X;
a data type: data with a UE identifier;
a data state: a generation period; and
a data validity period: one month.

Further, to reduce a data transmission amount, there are the following manners to send the data and the data profile.

(1) If there is only one data collection for the UE at the same time, the UE includes at least a data profile when sending a 1^{st} data packet, and a subsequent data packet indicates, by using indication information, whether the data belongs to a previous data profile association.

(2) If there are a plurality of data collections for the UE at the same time, the UE includes at least a data profile when sending a 1^{st} data packet, and a subsequent data packet carries only a data profile identifier, to indicate an association relationship between the data and the data profile.

After receiving the data profile, the third function node sends the data profile to the first function node, and registers data information that the UE is collecting or has collected as the second function node.

When the first function node receives a data request of the data consumption function node, and the data request needs to be provided by the UE, the related process is the same as that of Embodiment 2, and details are not described herein again.

### Embodiment 4

This embodiment relates to data collection within the core network or the radio access network.

In this embodiment, it is considered that both the first function node and the second function node belong to the network function of the core network, or both the first function node and the second function node belong to the network function of the radio access network. For example, the first function node is a core network data control function (CN-DCF), and the second function node is the network function of the core network such as AMF, SMF, NWDAF, and ADRF. Alternatively, the first function node is a radio access network data control function (RAN-DCF), and the second function node is the network function of the radio access network such as CU-CP, CU-UP, and DU.

If data collection is controlled by the CN-DCF or the RAN-DCF for collection, the CN-DCF or the RAN-DCF may generate and maintain the data profile by itself, without involving interaction between network functions. This embodiment focuses on data collection based on the existing CP or UP function configuration. For example, the NWDAF may collect data of the network function of the core network, and the CU-CP may collect L3 measurement of the radio access network and the like. The following process is briefly described by taking data collection within the radio access network as an example. The CU-CP, the CU-UP, or the DU has a limited storage space because of usually being used as the network function of the radio access network of the second function node, and a corresponding data validity period is short. If the RAN-DCF may obtain data from the second function node based on the data profile and data value analytics, to extend the data validity period, it may provide longer-term historical data for potential data reuse.

The related process is briefly described as follows.

Step 1: Optionally, the first function node sends data profile configuration information to the second function node, where the data profile configuration information includes at least one of an update cycle of the data profile and event configuration information that triggers update of the data profile. The event configuration information that triggers update of the data profile is, for example, to send the data profile when a data generation location appears, or to send the data profile when data of a data providing function node appears.

In some other embodiments of this application, the second function node may also obtain an identifier of the first function node and the data profile configuration information based on configuration information of a network management function.

Step 2: The second function node sends data profile registration or data profile update to the first function node based on the data profile configuration information. The data profile registration or the data profile update includes the data profile.

The data profile includes at least one of the following:
a data profile identifier such as M;
a data item such as RSRP, RSRQ, and PDCP delay;
a data collection control function node identifier, such as CU-CP ID, CU-UP ID, and DU ID;
a data providing function node identifier, such as CU-CP ID, CU-UP ID, and DU ID;
a data generation time, indicating a time when the data is generated;
a data generation location. If the data is generated by measuring an uplink signal by the second function node, the data generation location may not be included, or the information is provided only once because a location of the base station is usually fixed;
a measurement object corresponding to data, such as a measurement cell list, a Doppler range of a measurement perception target, or a DRB list of UE;
a data collection identifier, which may be a measurement ID configured by the base station;
a data state, because the validity period of the CU-CP, the CU-UP, or the DU is usually in a transmission time interval (TTI) or dozens of TTI intervals, the data state is usually the generation period or the use period. If further subdivided, the data state may also be in the decline period; and
a data validity period, where the validity period is usually in a TTI or dozens of TTI intervals.

Step 3: The first function node receives the data profile sent by the second function node, to obtain information of data that is being collected or has been collected by all controlled second function nodes.

When the first function node receives the data request of the data consumption function node, the related process is the same as that of Embodiment 1. This embodiment mainly describes that the first function node analyzes, based on historical data request information, that potential data may be reused, and obtains corresponding data based on the data profile for longer-term data storage. The related process is briefly described as follows.

Step 1: The first function node determines second data that needs to be stored for longer term, and sends a fourth data request to the second function node, where the fourth data request is used for updating a data validity period of the second data, the second data is data that is being collected or has been collected by the second function node and that is stored by the second function node, and the fourth data request includes at least one of the following: a data profile identifier and a data repository function node ID.

Step 2: The second function node sends the second data to the first function node based on the fourth data request, or sends the second data to the data repository function node.

Step 3: The first function node determines a data validity period of the second data (extends the data validity period), and updates the data validity period of the second data in the data profile and the data providing function node identifier. If the first function node receives the second data, the data providing function node identifier is the first function node identifier, and if the data repository function node receives the second data, the data providing function node identifier is the data repository function node identifier.

In this embodiment of this application, by using the data profile, in most cases, data isolation of different domains is achieved to a certain extent, and a data transmission amount is reduced with no need to send the data. For UE with a limited storage capacity, or a network architecture with data collection and data storage decoupled, it further supports the case in which the data profile registration node is different from a data providing node, and also supports the data providing node in registering the data profile as a proxy of the data collection node. It extends to support the case in which the data collection node is different from the data profile registration node, thereby avoiding unnecessary intra-domain information sharing during cross-domain data sharing, not only providing security, but also simplifying cross-domain data sharing. When the first function node of the core network receives data profile information uniformly, a more friendly data service for the data consumption function node is provided, and the data consumption function node is avoided from maintaining a mapping relationship between required data and a data control function.

The data collection method provided in this embodiment of this application may be performed by a data collection apparatus. In this embodiment of this application, a data collection apparatus provided in the embodiments of this application is described by using an example in which the data collection apparatus performs the data collection method.

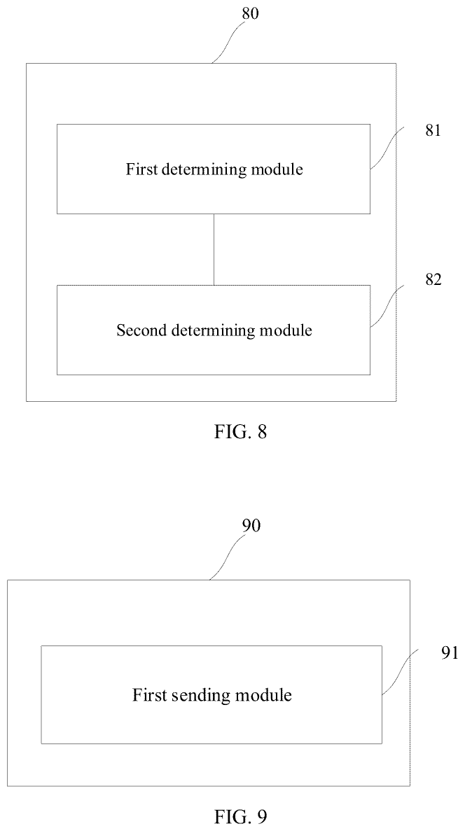

Referring to FIG. 8, an embodiment of this application further provides a data collection apparatus 80, including:
a first determining module 81, configured to determine, based on an obtained data profile after receiving a first data request, collection state information of first data requested by the first data request, where the data profile is used for describing information of data that is being collected or has been collected by a data providing function node; and
a second determining module 82, configured to determine, based on the collection state information of the first data, the data providing function node for providing the first data or a data repository function node, where the data repository function node is used for storing data collected by the data providing function node.

In this embodiment of this application, by using the data profile, when registering data, the data providing function node does not need to transmit the data that is being collected or has been collected to the first function node, and only needs to transmit the data profile, to reduce an amount of data to be transmitted. In addition, data isolation of different domains is achieved to a certain extent, and data security is improved.

In this embodiment of this application, optionally, the data profile includes at least one of the following:
a data profile identifier, used for uniquely identifying, within a control range of the first function node, the data profile and the data corresponding to the data profile;
a data item, used for indicating data information, where the data information includes at least one of the following: a data name, a data identifier, a data set name, and a data set identifier;
a data collection control function node identifier, used for identifying a data collection control function node, where the data collection control function node is used for controlling the data providing function node to collect data;
a data providing function node identifier;
a data repository function node identifier;
a data generation time;
a data generation location;
a measurement object corresponding to data;
a data collection identifier, used for uniquely identifying, within a control range of the data providing function node, an association relationship between at least two of the following: a data item, a data collection control function node identifier, a data providing function node identifier, a data generation time, a data generation location, and a measurement object corresponding to data;
a data type;
a data state, used for indicating information of a data life cycle in which data is located; and
a data validity period.

In this embodiment of this application, optionally, the first data request includes at least one of the following: a data item of the first data, a data generation time of the first data, a data generation location of the first data, and a measurement object corresponding to the first data.

In this embodiment of this application, optionally, the data providing function node includes at least one of the first function node and a second function node, and the second function node is a node for data collection or storage.

In this embodiment of this application, optionally, the data collection apparatus 80 further includes:

a first receiving module, configured to receive the data profile sent by the data providing function node or the data repository function node.

In this embodiment of this application, optionally, the data collection apparatus 80 further includes:
a first sending module, configured to send data profile configuration information to the data providing function node or the data repository function node, where the data profile configuration information includes at least one of an update cycle of the data profile and event configuration information that triggers update of the data profile.

In this embodiment of this application, optionally, the data collection apparatus 80 further includes:
a third determining module, configured to: before the determining, based on an obtained data profile, collection state information of first data requested by the first data request, determine that the first data request is authorized.

In this embodiment of this application, optionally, the data collection apparatus 80 further includes:
a second sending module, configured to send a first data response to a data consumption function node that sends the first data request, where the first data response includes at least one of the following: a data providing function node identifier, a data repository function node identifier, and a data collection identifier.

In this embodiment of this application, optionally, the data collection apparatus 80 further includes:
a third sending module, configured to send a second data request to the data providing function node or the data repository function node, where the second data request is used for instructing the data providing function node or the data repository function node to provide the first data to the data consumption function node.

In this embodiment of this application, optionally, the second sending module is configured to: when the collection state information of the first data indicates that the first data is being collected or has been collected, send a first data response to a data consumption function node that sends the first data request.

In this embodiment of this application, optionally, the data collection apparatus 80 further includes:
a first execution module, configured to: when the collection state information of the first data indicates that first partial data of the first data is being collected or has been collected, send data collection modification information to a data providing function node corresponding to the first partial data, and modify the data profile corresponding to the first partial data, where the data collection modification information is used for instructing to collect second partial data of the first data, and the second partial data is data of the first data other than the first partial data.

In this embodiment of this application, optionally, the data collection apparatus 80 further includes:
a second execution module, configured to: when the collection state information of the first data indicates that the first data is not collected, determine the data providing function node for collecting the first data, and send data collection configuration information to the data providing function node for collecting the first data, where the data collection configuration information includes at least one of the following: a data item of the first data, a data generation time of the first data, a data generation location of the first data, and a measurement object corresponding to the first data.

In this embodiment of this application, optionally, the data collection apparatus 80 further includes:
a fourth sending module, configured to send a second data response or first notification information to the data consumption function node that sends the first data request, where the second data response includes the first data, and the first notification information is used for notifying the data consumption function node that the first data is subscribed successfully.

In this embodiment of this application, optionally, the data collection apparatus 80 further includes:
a fifth sending module, configured to send a third data request to the data providing function node or the data repository function node, where the third data request is used for instructing the data providing function node or the data repository function node to provide the first data to the first function node; and
a second receiving module, configured to receive the first data sent by the data providing function node or the data repository function node.

In this embodiment of this application, optionally, the third data request includes a data profile identifier corresponding to the first data.

In this embodiment of this application, optionally, the fifth sending module is configured to: when the collection state information of the first data indicates that the first data is being collected or has been collected, send the third data request to the data providing function node or the data repository function node corresponding to the first data.

In this embodiment of this application, optionally, the data collection apparatus 80 further includes:
a third execution module, configured to: when the collection state information of the first data indicates that first partial data of the first data is being collected or has been collected, send data collection modification information to a data providing function node corresponding to the first partial data, and modify the data profile corresponding to the first data, where the data collection modification information is used for instructing the data providing function node corresponding to the first partial data to collect second partial data of the first data, and the second partial data is data of the first data other than the first partial data.

In this embodiment of this application, optionally, the data collection apparatus 80 further includes:
a fourth execution module, configured to: when the collection state information of the first data indicates that the first data is not collected, determine the data providing function node for collecting the first data, and send data collection configuration information to the data providing function node for collecting the first data, where the data collection configuration information includes at least one of the following: a data item of the first data, a data generation time of the first data, a data generation location of the first data, and a measurement object corresponding to the first data.

In this embodiment of this application, optionally, the data collection apparatus 80 further includes:
a sixth sending module, configured to: when the collection state information of the first data indicates that first partial data of the first data is being collected or has been collected, send a data format template of the first data to the data providing function node or the data repository function node.

In this embodiment of this application, optionally, the data collection apparatus 80 further includes:
a generation module, configured to: when the collection state information of the first data indicates that the first data is not collected, after the determining the data providing function node, generate a data profile corresponding to the data providing function node.

In this embodiment of this application, optionally, the data collection apparatus 80 further includes:
a seventh sending module, configured to send a fourth data request to the data providing function node, where the fourth data request is used for updating a data validity period of second data, the second data is data that is being collected or has been collected by the data providing function node and that is stored by the data providing function node, and the fourth data request includes at least one of the following: a data profile identifier, a data validity period, and a data repository function node identifier;
a third receiving module, configured to: receive the second data sent by the data providing function node, or receive second notification information sent by the data providing function node or the data repository function node, where the second notification information is used for indicating that the second data has been sent to the data repository function node by the data providing function node; and
an update module, configured to update a data validity period and a data providing function node identifier in a data profile corresponding to the second data.

In this embodiment of this application, optionally, the data collection apparatus 80 further includes:
an eighth sending module, configured to send data reporting configuration information to the data providing function node or the data repository function node, where the data reporting configuration information includes at least one of the following:
a data packet length;
distribution characteristics of data packet lengths;
a data packet time interval;
distribution characteristics of time intervals for data packet transmission;
whether the data providing function node performs data encryption;
whether the data providing function node performs data scrambling;
a key used by the data providing function node for data scrambling; and
a scrambling sequence used by the data providing function node for data scrambling.

In this embodiment of this application, optionally, the data collection apparatus 80 further includes at least one of the following:
a first processing module, configured to establish, modify, or release a data transmission channel for transmitting data by the data providing function node or the data repository function node; and
a second processing module, configured to perform QoS management on the data transmission channel.

In this embodiment of this application, optionally, the data collection apparatus 80 further includes:
a ninth sending module, configured to send data processing configuration information to at least one of the data providing function node, the data repository function node, and the data consumption function node, where the data processing configuration information includes at least one of the following: data preprocessing configuration information and data analytics configuration information.

The data collection apparatus in this embodiment of this application may be an electronic device, for example, an electronic device with an operating system, or may be a component in the electronic device, for example, an integrated circuit or a chip.

The data collection apparatus provided in this embodiment of this application can implement the processes in the method embodiment of FIG. 6, and a same technical effect is achieved. To avoid repetition, details are not described herein again.

Referring to FIG. 9, an embodiment of this application further provides a data collection apparatus 90, including:
a first sending module 91, configured to send a data profile to a first function node, where the data profile is used for describing information of data that is being collected or has been collected by a second function node.

In this embodiment of this application, optionally, the data profile includes at least one of the following:
a data profile identifier, used for uniquely identifying, within a control range of the first function node, the data profile and the data corresponding to the data profile;
a data item, used for indicating data information, where the data information includes at least one of the following: a data name, a data identifier, a data set name, and a data set identifier;
a data collection control function node identifier, used for identifying a data collection control function node, where the data collection control function node is used for controlling a data providing function node to collect data;
a data providing function node identifier, where the data providing function node is the second function node;
a data repository function node identifier, where the data repository function node is the third function node;
a data generation time;
a data generation location;
a measurement object corresponding to data;
a data collection identifier, used for uniquely identifying, within a control range of the second function node, an association relationship between at least two of the following: a data item, a data collection control function node identifier, a data providing function node identifier, a data generation time, a data generation location, and a measurement object corresponding to data;
a data type;
a data state, used for indicating information of a data life cycle in which data is located; and
a data validity period.

In this embodiment of this application, optionally, the data collection apparatus 90 further includes:
a first receiving module, configured to receive data profile configuration information sent by the first function node, where the data profile configuration information includes at least one of an update cycle of the data profile and event configuration information that triggers update of the data profile;
or
a first obtaining module, configured to obtain an identifier of the first function node and the data profile configuration information based on configuration information of a network management function.

In this embodiment of this application, optionally, the data collection apparatus 90 further includes:
a second receiving module, configured to receive a second data request sent by the first function node, where the second data request is used for instructing the second function node or the third function node to provide the first data to a data consumption function node;
or
a third receiving module, configured to receive a third data request sent by the first function node, where the third data request is used for instructing the second function node or the third function node to provide the first data to the first function node.

In this embodiment of this application, optionally, the third data request includes a data profile identifier corresponding to the first data.

In this embodiment of this application, optionally, the data collection apparatus 90 further includes:
a second sending module, configured to provide the first data to the first function node or the data consumption function node.

In this embodiment of this application, optionally, the data collection apparatus 90 further includes:
a fourth receiving module, configured to receive data collection modification information sent by the first function node, where the data collection modification information is used for instructing the second function node to collect second partial data of the first data, the second function node is collecting or has collected first partial data of the first data, and the second partial data is data of the first data other than the first partial data.

In this embodiment of this application, optionally, the data collection apparatus 90 further includes:
a fifth receiving module, configured to receive a data format template of the first data sent by the first function node.

In this embodiment of this application, optionally, the data collection apparatus 90 further includes:
a sixth receiving module, configured to receive a fourth data request sent by the first function node, where the fourth data request is used for updating a data validity period of second data, the second data is data that is being collected or has been collected by the second function node and that is stored by the second function node, and the fourth data request includes at least one of the following: a data profile identifier, a data validity period, and a data repository function node identifier; and
a third sending module, configured to send the second data to the first function node or the third function node based on the fourth data request.

In this embodiment of this application, optionally, the data collection apparatus 90 further includes:

a seventh receiving module, configured to receive data reporting configuration information sent by the first function node, where the data reporting configuration information includes at least one of the following: a data packet length; distribution characteristics of data packet lengths; a data packet time interval; distribution characteristics of time intervals for data packet transmission; whether to perform data encryption; whether to perform data scrambling; a key used for data scrambling; and a scrambling sequence used for data scrambling; and
a fourth sending module, configured to send data to the first function node or the data consumption function node based on the data reporting configuration information.

In this embodiment of this application, optionally, the data collection apparatus 90 further includes:
an eighth receiving module, configured to receive data processing configuration information sent by the first function node, where the data processing configuration information includes at least one of the following: data preprocessing configuration information and data analytics configuration information; and
a processing module, configured to process data based on the data processing configuration information.

The data collection apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The data collection apparatus provided in this embodiment of this application can implement the processes in the method embodiment of FIG. 7, and a same technical effect is achieved. To avoid repetition, details are not described herein again.

As shown in FIG. 10, an embodiment of this application further provides a communication device 100, including a processor 101 and a memory 102, and the memory 102 stores a program or an instruction that can be run on the processor 101. For example, in a case that the communication device 100 is a first function node, when the program or the instruction is executed by the processor 101, the steps of the data collection method embodiment performed by the first function node are implemented, and a same technical effect can be achieved. In a case that the communication device 100 is a second function node or a third function node, when the program or the instruction is executed by the processor 101, the steps of the data collection method embodiment performed by the second function node or the third function node are implemented, and a same technical effect can be achieved. To avoid repetition, details are not described herein again.

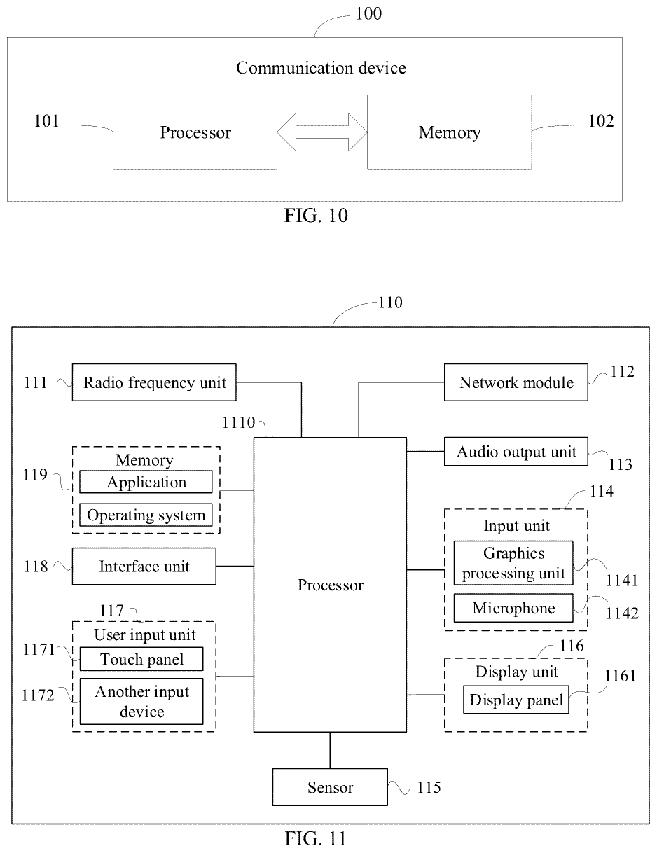

An embodiment of this application further provides a terminal, including a processor and a communication interface. The communication interface is coupled to the processor, and the processor is configured to run a program or an instruction to implement the steps of the method embodiment shown in FIG. 7. The terminal embodiment is corresponding to the method embodiment performed by the second function node, each implementation process and implementation of the method embodiment can be applied to the terminal embodiment, and a same technical effect can be achieved. Specifically, FIG. 11 is a schematic diagram of a hardware structure of a terminal according to an embodiment of this application.

The terminal 110 includes but is not limited to at least a part of components such as a radio frequency unit 111, a network module 112, an audio output unit 113, an input unit 114, a sensor 115, a display unit 116, a user input unit 117, an interface unit 118, a memory 119, and a processor 1110.

It may be understood by a person skilled in the art that the terminal 110 may further include a power supply (such as a battery) that supplies power to each component. The power supply may be logically connected to the processor 1110 by using a power management system, to implement functions such as charging, discharging, and power consumption management by using the power management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 114 may include a graphics processing unit (GPU) 1141 and a microphone 1142. The GPU 1141 processes picture data of a static picture or a video obtained by a picture capture apparatus (for example, a camera) in a video capture mode or a picture capture mode. The display unit 116 may include a display panel 1161, and the display panel 1161 may be configured in a form of a liquid crystal display, an organic light-emitting diode, or the like. The user input unit 117 includes at least one of a touch panel 1171 and another input device 1172. The touch panel 1171 is also referred to as a touchscreen. The touch panel 1171 may include two parts: a touch detection apparatus and a touch controller. The another input device 1172 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 111 may transmit the downlink data to the processor 1110 for processing. In addition, the radio frequency unit 111 may send uplink data to the network side device. Generally, the radio frequency unit 111 includes but is not limited to an antenna, an amplifier, a transceiver, a coupler, a low noise amplifier, a duplexer, and the like.

The memory 119 may be configured to store a software program or an instruction and various data. The memory 119 may mainly include a first storage area for storing a program or an instruction and a second storage area for storing data. The first storage area may store an operating system, and an application or an instruction required by at least one function (for example, a sound playing function or an image playing function). In addition, the memory 119 may include a volatile memory or a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 119 in this embodiment of this application includes but is not limited to these memories and any memory of another proper type.

The processor 1110 may include one or more processing units. Optionally, an application processor and a modem processor are integrated into the processor 1110. The application processor mainly processes an operating system, a user interface, an application, or the like. The modem processor mainly processes a wireless communication signal, for example, a baseband processor. It may be understood that, alternatively, the modem processor may not be integrated into the processor 1110.

The radio frequency unit 111 is configured to send a data profile to a first function node, where the data profile is used for describing information of data that is being collected or has been collected by the second function node, and the third function node is used for storing the data collected by the second function node.

In this embodiment of this application, by using the data profile, when registering data, the data providing function node does not need to transmit the data that is being collected or has been collected to the first function node, and only needs to transmit the data profile, to reduce an amount of data to be transmitted. In addition, data isolation of different domains is achieved to a certain extent, and data security is improved.

It can be understood that for the implementation process of each implementation given in this embodiment, refer to related description of the method embodiment performed by the second function node, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 6 or FIG. 7. This network side device embodiment is corresponding to the foregoing method embodiment. Each implementation process and implementation of the foregoing method embodiment may be applicable to this network side device embodiment, and a same technical effect can be achieved.

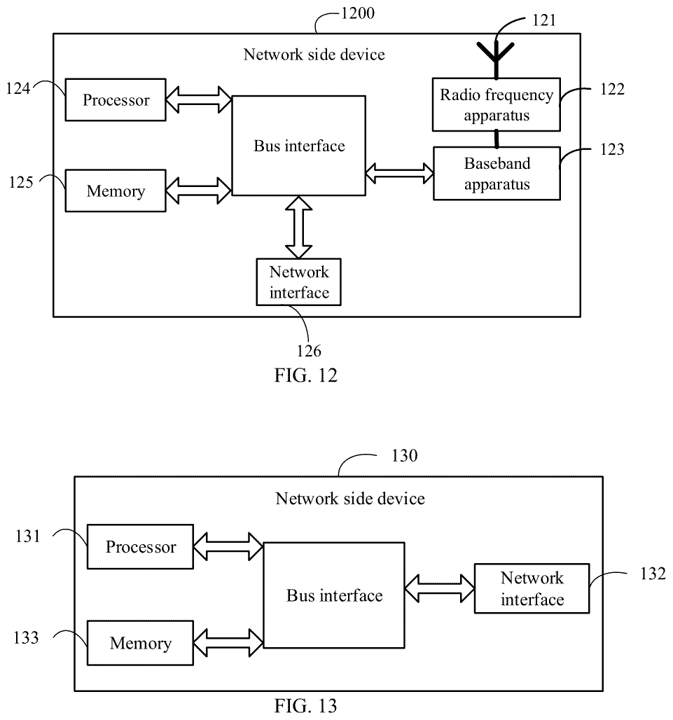

Specifically, an embodiment of this application further provides a network side device. As shown in FIG. 12, the network side device 120 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes information that needs to be sent, and sends processed information to the radio frequency apparatus 122. The radio frequency apparatus 122 processes the received information, and sends processed information through the antenna 121.

In the foregoing embodiment, the method performed by the network side device may be implemented in the baseband apparatus 123. The baseband apparatus 123 includes a baseband processor.

For example, the baseband apparatus 123 may include at least one baseband board. A plurality of chips are disposed on the baseband board. As shown in FIG. 12, one chip is, for example, a baseband processor, and is connected to the memory 125 by using a bus interface, to invoke a program in the memory 125 to perform the operations of the network device shown in the foregoing method embodiment.

The network side device may further include a network interface 126, and the interface is, for example, a common public radio interface (CPRI).

Specifically, the network side device 120 in this embodiment of this application further includes an instruction or a program that is stored in the memory 125 and that can be run on the processor 124. The processor 124 invokes the instruction or the program in the memory 125 to perform the method performed by the modules shown in FIG. 8 or FIG. 9, and a same technical effect is achieved. To avoid repetition, details are not described herein again.

Specifically, an embodiment of this application further provides a network side device. As shown in FIG. 13, a network side device 13 includes a processor 131, a network interface 132, and a memory 133. The network interface 132 is, for example, a common public radio interface (CPRI).

Specifically, the network side device 130 in this embodiment of this application further includes an instruction or a program that is stored in the memory 133 and that can be run on the processor 131. The processor 131 invokes the instruction or the program in the memory 133 to perform the method performed by the modules shown in FIG. 8 or FIG. 9, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing embodiments of the data collection method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the foregoing embodiments of the data collection method, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product, the computer program/program product is stored in a storage medium, and the computer program/program product is executed by at least one processor to implement the processes of the foregoing embodiment of the data collection method, and a same technical effect can be achieved. To avoid repetition, details are not described herein again.

An embodiment of this application further provides a communication system, including a first function node and a second function node/third function node, where the first function node may be configured to perform the steps of the method performed by the first function node, and the second function node/third function node may be configured to perform the steps of the method performed by the second function node/third function node.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes a plurality of instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. A data collection method, comprising:
determining, by a first function node based on an obtained data profile after receiving a first data request, collection state information of first data requested by the first data request, wherein the data profile is used for describing information of data that is being collected or has been collected by a data providing function node; and
determining, by the first function node based on the collection state information of the first data, a data providing function node for providing the first data or a data repository function node, wherein the data repository function node is used for storing data collected by the data providing function node.

2. The method according to claim 1, wherein the data profile comprises at least one of the following:
a data profile identifier, used for uniquely identifying, within a control range of the first function node, the data profile and the data corresponding to the data profile;
a data item, used for indicating data information, wherein the data information comprises at least one of the following: a data name, a data identifier, a data set name, or a data set identifier;
a data collection control function node identifier, used for identifying a data collection control function node, wherein the data collection control function node is used for controlling the data providing function node to collect data;
a data providing function node identifier;
a data repository function node identifier;
a data generation time;
a data generation location;
a measurement object corresponding to data;
a data collection identifier, used for uniquely identifying, within a control range of the data providing function node, an association relationship between at least two of the following: a data item, a data collection control function node identifier, a data providing function node identifier, a data generation time, a data generation location, and a measurement object corresponding to data;
a data type;
a data state, used for indicating information of a data life cycle in which data is located; or
a data validity period.

3. The method according to claim 1, wherein the first data request comprises at least one of the following: a data item of the first data, a data generation time of the first data, a data generation location of the first data, or a measurement object corresponding to the first data; or,
wherein the data providing function node comprises at least one of the first function node or a second function node, and the second function node is a node for data collection or storage; or,
wherein the method further comprises:
sending, by the first function node, a fourth data request to the data providing function node, wherein the fourth data request is used for updating a data validity period of second data, the second data is data that is being collected or has been collected by the data providing function node and that is stored by the data providing function node, and the fourth data request comprises at least one of the following: a data profile identifier, a data validity period, or a data repository function node identifier;
receiving, by the first function node, the second data sent by the data providing function node, or receiving second notification information sent by the data providing function node or the data repository function node, wherein the second notification information is used for indicating that the second data has been sent to the data repository function node by the data providing function node; and
updating, by the first function node, a data validity period and a data providing function node identifier in a data profile corresponding to the second data.

4. The method according to claim 1, wherein the method further comprises:
receiving, by the first function node, the data profile sent by the data providing function node or the data repository function node; or,
wherein the method further comprises:
sending, by the first function node, data profile configuration information to the data providing function node or the data repository function node, wherein the data profile configuration information comprises at least one of an update cycle of the data profile or event configuration information that triggers update of the data profile; or,
before the determining, based on an obtained data profile, collection state information of first data requested by the first data request, further comprising:
determining, by the first function node, that the first data request is authorized.

5. The method according to claim 1, after the determining, by the first function node based on the collection state information of the first data, a data providing function node for providing the first data or a data repository function node, further comprising:
sending, by the first function node, a first data response to a data consumption function node that sends the first data request, wherein the first data response comprises at least one of the following: a data providing function node identifier, a data repository function node identifier, or a data collection identifier;
wherein the method further comprises:
sending, by the first function node, a second data request to the data providing function node or the data repository function node, wherein the second data request is used for instructing the data providing function node or the data repository function node to provide the first data to the data consumption function node.

6. The method according to claim 5, wherein
the sending, by the first function node, a first data response to a data consumption function node that sends the first data request comprises:
when the collection state information of the first data indicates that the first data is being collected or has been collected, sending, by the first function node, the first data response to the data consumption function node that sends the first data request;
or
when the collection state information of the first data indicates that first partial data of the first data is being collected or has been collected, before the sending, by the first function node, a first data response to a data consumption function node that sends the first data request, further comprising:
sending, by the first function node, data collection modification information to a data providing function node corresponding to the first partial data, and modifying a data profile corresponding to the first partial data, wherein the data collection modification information is used for instructing to collect second partial data of the first data, and the second partial data is data of the first data other than the first partial data;
or
when the collection state information of the first data indicates that the first data is not collected, before the sending, by the first function node, a first data response to a data consumption function node that sends the first data request, further comprising:
determining, by the first function node, a data providing function node for collecting the first data, and sending data collection configuration information to the data providing function node for collecting the first data, wherein the data collection configuration information comprises at least one of the following: a data item of the first data, a data generation time of the first data, a data generation location of the first data, or a measurement object corresponding to the first data.

7. The method according to claim 1, after the determining the data providing function node for providing the first data or a data repository function node, further comprising:
sending, by the first function node, a second data response or first notification information to a data consumption function node that sends the first data request, wherein the second data response comprises the first data, and the first notification information is used for notifying the data consumption function node that the first data is subscribed successfully.

8. The method according to claim 7, before the sending, by the first function node, a second data response or first notification information to the data consumption function node that sends the first data request, further comprising:
sending, by the first function node, a third data request to the data providing function node or the data repository function node, wherein the third data request is used for instructing the data providing function node or the data repository function node to provide the first data to the first function node; and
receiving, by the first function node, the first data sent by the data providing function node or the data repository function node.

9. The method according to claim 8, wherein the third data request comprises a data profile identifier corresponding to the first data; or,
wherein
the sending, by the first function node, a third data request to the data providing function node or the data repository function node comprises:
when the collection state information of the first data indicates that the first data is being collected or has been collected, sending, by the first function node, the third data request to the data providing function node or the data repository function node corresponding to the first data;
or
when the collection state information of the first data indicates that first partial data of the first data is being collected or has been collected, before the sending, by the first function node, the third data request to the data providing function node or the data repository function node, further comprising:
sending, by the first function node, data collection modification information to a data providing function node corresponding to the first partial data, and modifying the data profile corresponding to the first data, wherein the data collection modification information is used for instructing to collect second partial data of the first data, and the second partial data is data of the first data other than the first partial data;
or
when the collection state information of the first data indicates that the first data is not collected, before the sending, by the first function node, the third data request to the data providing function node or the data repository function node, further comprising:
determining, by the first function node, a data providing function node for collecting the first data, and sending data collection configuration information to the data providing function node for collecting the first data, wherein the data collection configuration information comprises at least one of the following: a data item of the first data, a data generation time of the first data, a data generation location of the first data, or a measurement object corresponding to the first data.

10. The method according to claim 5, wherein when the collection state information of the first data indicates that first partial data of the first data is being collected or has been collected, the method further comprises:
sending, by the first function node, a data format template of the first data to the data providing function node or the data repository function node; or,
when the collection state information of the first data indicates that the first data is not collected, after the determining, by the first function node, the data providing function node, further comprising:
generating, by the first function node, a data profile corresponding to the data providing function node.

11. The method according to claim 5, wherein the method further comprises:
sending, by the first function node, data reporting configuration information to the data providing function node or the data repository function node, wherein the data reporting configuration information comprises at least one of the following:
a data packet length;
distribution characteristics of data packet lengths;
a data packet time interval;
distribution characteristics of time intervals for data packet transmission;
whether the data providing function node performs data encryption;
whether the data providing function node performs data scrambling;
a key used by the data providing function node for data scrambling; or
a scrambling sequence used by the data providing function node for data scrambling; or,
wherein the method further comprises at least one of the following:
establishing, modifying, or releasing, by the first function node, a data transmission channel for transmitting data by the data providing function node or the data repository function node; or
performing, by the first function node, QoS management on the data transmission channel; or,
wherein the method further comprises:
sending, by the first function node, data processing configuration information to at least one of the data providing function node, the data repository function node, or the data consumption function node, wherein the data processing configuration information comprises at least one of the following: data preprocessing configuration information or data analytics configuration information.

12. A data collection method, comprising:
sending, by a second function node or a third function node, a data profile to a first function node, wherein the data profile is used for describing information of data that is being collected or has been collected by the second function node, and the third function node is used for storing the data collected by the second function node.

13. The method according to claim 12, wherein the data profile comprises at least one of the following:
a data profile identifier, used for uniquely identifying, within a control range of the first function node, the data profile and the data corresponding to the data profile;
a data item, used for indicating data information, wherein the data information comprises at least one of the following: a data name, a data identifier, a data set name, or a data set identifier;
a data collection control function node identifier, used for identifying a data collection control function node, wherein the data collection control function node is used for controlling a data providing function node to collect data;
a data providing function node identifier, wherein the data providing function node is the second function node;
a data repository function node identifier, wherein the data repository function node is the third function node;
a data generation time;
a data generation location;
a measurement object corresponding to data;
a data collection identifier, used for uniquely identifying, within a control range of the second function node, an association relationship between at least two of the following: a data item, a data collection control function node identifier, a data providing function node identifier, a data generation time, a data generation location, and a measurement object corresponding to data;
a data type;
a data state, used for indicating information of a data life cycle in which data is located; or
a data validity period; and/or,
wherein the method further comprises:
receiving, by the second function node or the third function node, data profile configuration information sent by the first function node, wherein the data profile configuration information comprises at least one of an update cycle of the data profile or event configuration information that triggers update of the data profile;
or
obtaining, by the second function node or the third function node, an identifier of the first function node and the data profile configuration information based on configuration information of a network management function.

14. The method according to claim 12, wherein the method further comprises:
receiving, by the second function node or the third function node, a second data request sent by the first function node, wherein the second data request is used for instructing the second function node or the third function node to provide the first data to a data consumption function node;
or
receiving, by the second function node or the third function node, a third data request sent by the first function node, wherein the third data request is used for instructing the second function node or the third function node to provide the first data to the first function node.

15. The method according to claim 14, wherein the third data request comprises a data profile identifier corresponding to the first data; or,
wherein the method further comprises:
providing, by the second function node or the third function node, the first data to the first function node or the data consumption function node.

16. The method according to claim 12, wherein the method further comprises:
receiving, by the second function node, data collection modification information sent by the first function node, wherein the data collection modification information is used for instructing the second function node to collect second partial data of the first data, the second function node is collecting or has collected first partial data of the first data, and the second partial data is data of the first data other than the first partial data;
wherein the method further comprises:
receiving, by the second function node or the third function node, a data format template of the first data sent by the first function node.

17. The method according to claim 12, wherein the method further comprises:
receiving, by the second function node, a fourth data request sent by the first function node, wherein the fourth data request is used for updating a data validity period of second data, the second data is data that is being collected or has been collected by the second function node and that is stored by the second function node, and the fourth data request comprises at least one of the following: a data profile identifier, a data validity period, or a data repository function node identifier; and
sending, by the second function node, the second data to the first function node or the third function node based on the fourth data request.

18. The method according to claim 12, wherein the method further comprises:
receiving, by the second function node or the third function node, data reporting configuration information sent by the first function node, wherein the data reporting configuration information comprises at least one of the following: a data packet length; distribution characteristics of data packet lengths; a data packet time interval; distribution characteristics of time intervals for data packet transmission; whether to perform data encryption; whether to perform data scrambling; a key used for data scrambling; or a scrambling sequence used for data scrambling; and
sending, by the second function node or the third function node, data to the first function node or the data consumption function node based on the data reporting configuration information; or,
wherein the method further comprises:
receiving, by the second function node or the third function node, data processing configuration information sent by the first function node, wherein the data processing configuration information comprises at least one of the following: data preprocessing configuration information or data analytics configuration information; and
processing, by the second function node or the third function node, data based on the data processing configuration information.

19. A communication device, comprising a processor and a memory, wherein the memory stores a program or an instruction that can be run on the processor, wherein the program or the instruction, when executed by the processor, causes the communication device to perform:
determining, based on an obtained data profile after receiving a first data request, collection state information of first data requested by the first data request, wherein the data 5 profile is used for describing information of data that is being collected or has been collected by a data providing function node; and
determining, based on the collection state information of the first data, a data providing function node for providing the first data or a data repository function node, wherein the data repository function node is used for storing data collected by the data providing function node.

20. A communication device, comprising a processor and a memory, wherein the memory stores a program or an instruction that can be run on the processor, and when the program or the instruction is executed by the processor, the steps of the data collection method according to claim 12 are implemented.
